(19) United States
(12) Patent Application Publication
(10) Pub. No.: US 2007/0291703 A1
(43) Pub. Date: Dec. 20, 2007

(54) Method and Mobile Terminal Arrangement for Fast Switching Between Multiple Peripherals

(76) Inventor: Thomas Muller, Castrop-Rauxel (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/582,208

(22) PCT Filed: Dec. 10, 2003
(86) PCT No.: PCT/IB03/05814

§ 371 Date: Aug. 13, 2007

(51) Int. Cl. H04Q 7/24

(52) U.S. Cl. 370/338

(57) ABSTRACT

The present invention relates to an improved method and arrangements for fast constitution of a wireless communication connection between at least two portable devices, wherein preferably one of the portable devices is capable for cellular communications on a cellular network. Particularly, the present invention relates to an arrangement of several radio terminal devices and a multipart radio terminal device arrangement, which comprises a core device and several peripheral devices. The fast constitution includes an establishment of a wireless communication connection between the participating portable devices on the basis of configuration information obtained by the means of identification means allowing information exchange between devices implementing such identification means with spacious proximity. The fast constitution includes additionally a transfer of control over either of the devices to the other one, wherein the transfer comprises a selective and/or at least partial transfer of control over functions, operations and/or interfaces such as user interfaces and/or applications. The transfer of the control is preferably performed on the basis of the configuration information.

The present invention relates to an improved method and arrangement for fast constitution of a wireless communication connection between at least two portable devices, wherein preferably one of the portable devices is capable of cellular communications. Particularly, the fast constitution includes establishing of a wireless communication connection providing for device interoperability. More particularly, the present invention relates to an arrangement of several radio terminal devices and a multipart radio terminal device arrangement, which comprises a core device and several peripheral devices.

Different peripheral devices for radio terminal devices are well known in the field of radio communication. The most common peripheral device for radio terminal devices is represented by a wireless headset preferably connected thereto by the means of wireless connections. So-called multipart radio terminal devices being presently under development represent a continuation of this concept. A multipart radio terminal device arrangement is basically constituted by a core device, to which a plurality of specific peripheral devices is connected. Type-specifically, the core device serves for communications with the public land mobile network (PLMN) and routes specifically and selectively the communications with the public land mobile network (PLMN) to one or more peripheral devices acting as (physical and logical) interfaces for user interaction; i.e. specifically and selectively with respect to the functionality of the one or more peripheral devices.

Design and functionality of the peripheral devices fit in with demands of customers for adaptation of multipart radio terminal devices to different fields of use in order to allow substitution for several separate radio terminal devices each adapted to one specific field of use. For instance, one peripheral device may be optimized for basic phone functionality required for private use, another one may be optimized for contact handling, messaging, browsing etc functionality required primarily for business use, a further one may be optimized for hand-free phone functionality such as used in motor vehicles, another further one may be optimized for video and music reproduction functionality and the like, only to present a selection of possible functionalities of specific peripheral devices.

Wireless connections are usually employed between core device and peripheral devices to enable flexibility and usability requested by users. Conventionally, low power radio frequency connections, for instance in accordance with the Bluetooth wireless communication standard, are selected for wireless connections. The establishment of wireless connections between a core device and a peripheral device follows conventionally standardized procedures, which on the one hand provide for flexibility and on the other hand guarantee security issues such that the user has control over the establishment. In view of multipart radio terminal device arrangements, where the core device does not provide any user interfaces or the user interface is restricted to narrow limits and where one or more peripheral devices take over the user interface functionality to users of the multipart radio terminal device arrangements, the users have to manage the hand over of the interface functionality between the peripheral devices when connecting a peripheral device to the core device.

A problem arises in this context when users of less technical knowledge have to handle such standardized procedures for establishing wireless connections and handing over interface functionality. To meet security issues, user interactions during establishing and handing over procedures are required, which may overtax the knowledge of an average user. Although users are conventionally guided by adequate user interfaces through these procedures nevertheless the processes may appear confusing to users.

Another problem arises in this context when taking the usability of such procedures into consideration. The user interactions required during establishing and handing over procedures are above all disadvantageous when peripheral devices of a multipart radio terminal device arrangement are exchanged, since user interactions are required each time of exchange. This circumstance may appear to users as being elaborate and awkward.

The same problems arise also in the field of wireless communication connections within an arrangement including several separate radio terminal devices. In such an arrangement the establishing of a communication connection therebetween and the transferring of control over one of the radio terminal devices to another one of the arrangement is also applicable for instance within server-client application and multi-user application environment.

The overall object of the present invention is to overcome the above-described problems.

In particular, a detail object of the present invention is to provide a method of allowing fast constitution of communication connections within an arrangement of radio terminal devices and within a radio terminal device arrangements, respectively.

Another detail object of the present invention is to provide an improved arrangement of radio terminal devices and radio terminal device arrangements, respectively, adapted for the aforementioned method of fast constitution.

Advantages of the present invention will become apparent to the reader of the present invention when reading the detailed description referring to embodiments of the present invention, on the basis of which the inventive concept is easily understandable.

According to a first aspect of the invention, a mobile device is provided, which is arranged for fast constitution of a communication connection. The constituted communication connection is dedicated for device interoperability with at least one counterpart mobile device. The term device interoperability shall be understood as interoperability with at least control exercised and operable by one of the participating mobile devices over the other one. Therefore, the mobile device comprises at least one wireless communication interface and identification means. The wireless communication interface is arranged for wireless communication with the counterpart mobile device, which preferably implements a corresponding wireless communication interface. The identification means are arranged to obtain configuration information from the counterpart mobile device being arranged to provide this configuration information. The obtained configuration information is provided to allow establishment of a communication connection with the counterpart mobile device via the wireless communication interface and to allow hand over of the at least partial control over the mobile device to the counterpart mobile device or vice versa.

In accordance with the inventive concept, the communication connection is separately established; i.e. particularly separate from the information exchange being also operated wireless between the mobile device and the counterpart mobile device via the identification means.

Moreover, the communication connection is arranged for performing control by one of the participating mobile device over the other one. That means that according to an embodiment of the invention the control over the mobile device is at least partially transferred to the counterpart mobile device or the control over the counterpart mobile device is at least partially transferred to the mobile device.

According to another embodiment of the invention, the transfer of the at least partial control corresponds to the capability and functionality of that one mobile device (i.e. the mobile device or the counterpart mobile device), via which the control is exercised, and/or the capability and functionality of that one mobile device (i.e. the mobile device or the counterpart mobile device), which is under control.

According to yet another embodiment of the invention, the control may relate to a control over operations of the devices, i.e. the mobile device and/or the counterpart mobile device. The control may address to a control over one or more interfaces of the devices and/or the control may be dedicated to a control over one or more applications carried out on either one or both of the devices. The one or more interfaces of the device include also user interfaces operable with users for operating mobile devices.

According to a further embodiment of the invention, the identification means comprise radio frequency identification (RFID) means including for instance a radio frequency identification (RFID) reader, a radio frequency identification (RFID) reader with writing capability and a radio frequency identification (RFID) transponder (tag).

According to yet a further embodiment of the invention, the counterpart mobile device implements also identification means operable with the identification means of the mobile device for exchange of the configuration information. The identification means are preferably radio frequency identification (RFID) means including for instance a radio frequency identification (RFID) reader, a radio frequency identification (RFID) reader with writing capability and a radio frequency identification (RFID) transponder (tag).

According to another further embodiment of the invention, the configuration information comprises at least one out of a set of information including communication interface configuration information, device type information, device identifier (ID) information, and personal identifier (ID) information.

According to an additional embodiment of the invention, the wireless communication interface may be realized as a low power radio frequency communication interface, an infrared-based (IRDA) communication interface or a cellular communication interface.

According to a further additional embodiment of the invention, the low power radio frequency interface may be implemented as a Bluetooth interface or a wireless local area network interface.

According to yet an additional embodiment of the invention, at least one of the mobile device or the counterpart mobile terminal device is a radio terminal device capable for cellular communications. Preferably, the mobile device is capable for cellular communications on a cellular network.

According to yet a further additional embodiment of the invention, at least one of the mobile device and the counterpart device is a core device of a multipart radio terminal device arrangement and the other one is a peripheral device of the multipart radio terminal device arrangement. Preferably, the mobile device is the core device and the counterpart mobile device is the peripheral device.

According to a second aspect of the invention, a system is provided which is arranged for fast constitution of a communication connection. The constituted communication connection is dedicated for device interoperability between a mobile device and a counterpart mobile device comprised by the system. The mobile device and the counterpart mobile device each comprise at least one wireless communication interface and identification means. The wireless communication interfaces are arranged for wireless communications between the mobile device and the counterpart mobile device. The identification means are arranged to allow obtaining configuration information by the mobile device from the counterpart mobile device. The obtained configuration information is provided to allow establishment of a communication connection between the mobile device and the counterpart mobile device via the wireless communication interfaces and to allow hand over of the at least partial control over the mobile device to the counterpart mobile device or vice versa.

According to a third aspect of the invention, a method is provided, which allows of fast constitution of a communication connection providing for device interoperability of a mobile device operable with said method with a counterpart mobile device. At first, configuration information is obtained from the counterpart mobile device by identification means implemented in the mobile device to enable information exchange. Next, the configuration information is processed by the mobile device in order to establish a communication connection to the counterpart mobile device and to transfer at least partial control. The communication connection is established by a wireless communication interface implemented in the mobile device. The transfer of the at least partial control is performable as at least partially handing over control over either the mobile device or the counterpart mobile device and vice versa, respectively.

In accordance with the inventive concept, the communication connection is separately established; i.e. particularly separate from the information exchange being also operated wireless between the mobile device and the counterpart mobile device via the identification means.

Moreover, the communication connection is arranged for performing control by one of the participating mobile device over the other one. That means that according to an embodiment of the invention, the control over the mobile device is at least partially transferred to the counterpart mobile device or the control over the counterpart mobile device is at least partially transferred to the mobile device.

According to another embodiment of the invention, the at least partial transfer of the control corresponds to a transfer of at least partial control. The at least partial transfer of the control and the transfer of at least partial control may correspond in turn to a selective transfer of the control and the transfer of selective control, respectively, the extent of which depends on the capability and functionality of that one mobile device (i.e. the mobile device or the counterpart mobile device), via which the control is exercised, and/or the capability and functionality of that one mobile device (i.e. the mobile device or the counterpart mobile device), which is under control.

According to an embodiment of the invention, it is checked whether the counterpart mobile device is a trusted device. The checking is carried out on the basis of the configuration information, which preferably includes authentication information and/or personal identifier (ID) information. The configuration information and at least a part of the configuration information are checked against a list of information relating to trusted device, respectively. In case of matching the counterpart mobile device is rated to be trustworthy such that the constitution of the communication connection can be performed.

According to another embodiment of the invention, the transfer of the control is carried out on the basis of the configuration information, which preferably includes device type information and/or device identifier information. With accordance with such information the ability of the devices concerning the taking over of control functions is determinable.

According to yet another embodiment of the invention, in case a communication connection has been constituted before and is actually present to a third mobile device and in case the constituted communication connection shall be substituted by one to the counterpart device, that actually present communication connection is disestablished. Next, control that has been exercised before by the third mobile device is handed over to the counterpart device.

According to a further embodiment of the invention, the mobile device corresponds to any embodiment of a mobile device according to the invention as defined above.

According to a fourth aspect of the invention, computer program product for executing a method allowing of fast constitution of a communication connection providing for device interoperability is provided. The computer program product comprises program code sections for carrying out the steps of the method according to an aforementioned embodiment of the invention, when the program is run on a computer, a terminal, a network device, a mobile terminal, a mobile communication enabled terminal or an application specific integrated circuit. Alternatively, an application specific integrated circuit (ASIC) may implement one or more instructions that are adapted to realize the aforementioned steps of the method of an aforementioned embodiment of the invention, i.e. equivalent with the aforementioned computer program product.

According to a fifth aspect of the invention, a computer program product is provided, which comprises program code sections stored on a machine-readable medium for carrying out the steps of the method according to an aforementioned embodiment of the invention, when the computer program product is run on a computer, a terminal, a network device, a mobile terminal, or a mobile communication enabled terminal.

According to a sixth aspect of the invention, a computer data signal embodied in a carrier wave and representing instructions is provided which when executed by a processor cause the steps of the method according to an aforementioned embodiment of the invention to be carried out.

In the following, the present invention will be described in greater detail with reference to embodiments and the accompanying drawings, in which

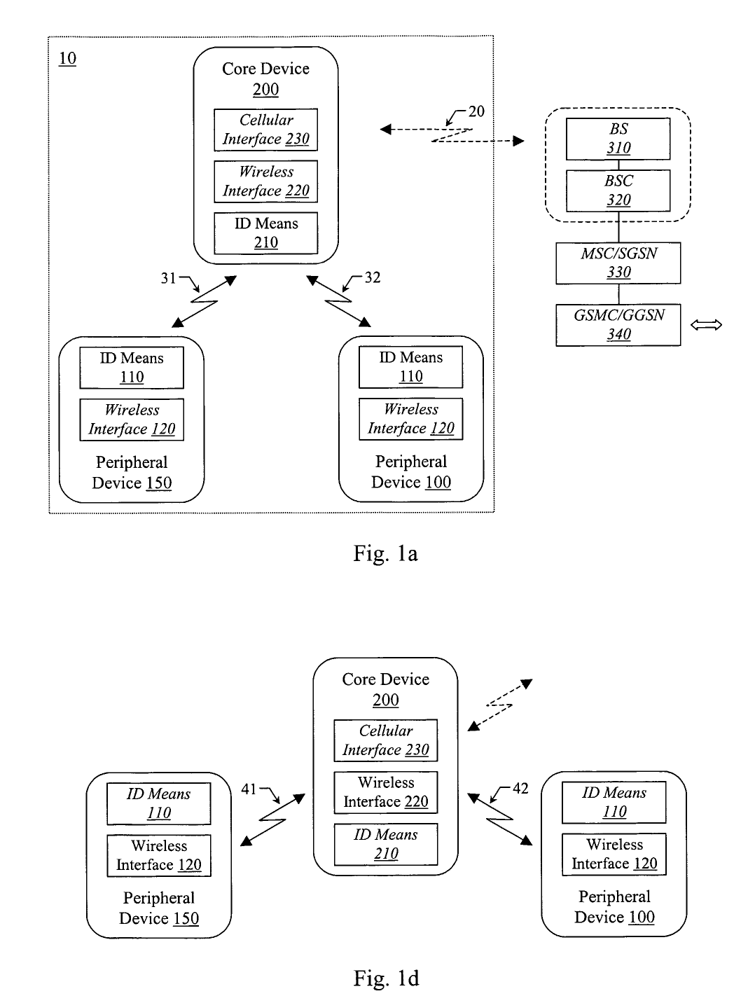

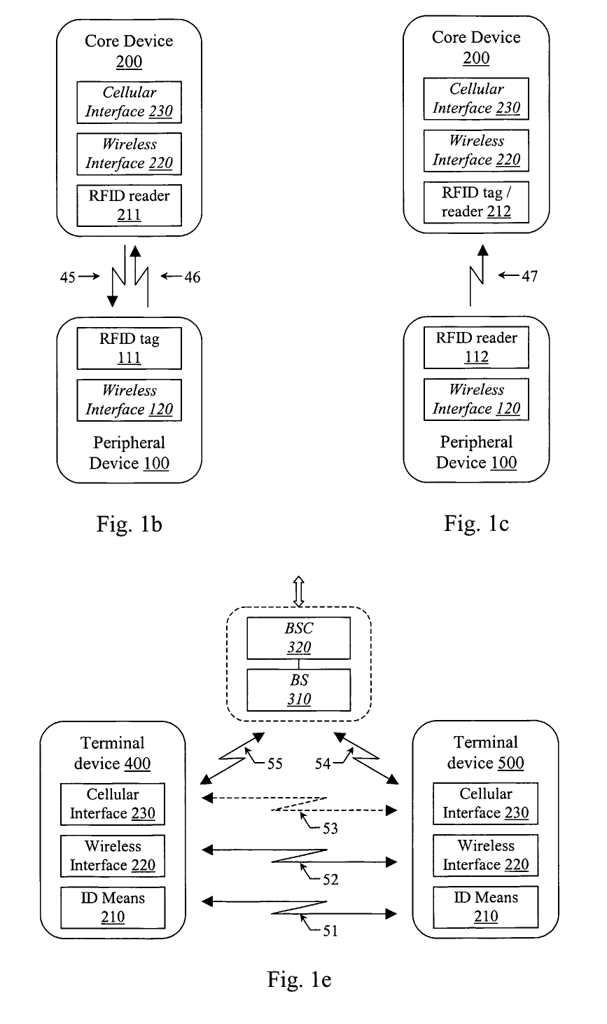

FIG. 1a illustrates schematically a first radio terminal device arrangement during initiation according to an embodiment of the present invention;

FIG. 1b illustrates schematically a particular embodiment of the first radio terminal device arrangement of FIG. 1a according to an embodiment of the present invention;

FIG. 1c illustrates schematically another particular embodiment of the first radio terminal device arrangement of FIG. 1a according to an embodiment of the present invention;

FIG. 1d illustrates schematically the first radio terminal device arrangement of FIG. 1a during operation according to an embodiment of the present invention;

FIG. 1e illustrates schematically an arrangement of radio terminal devices according to an embodiment of the present invention;

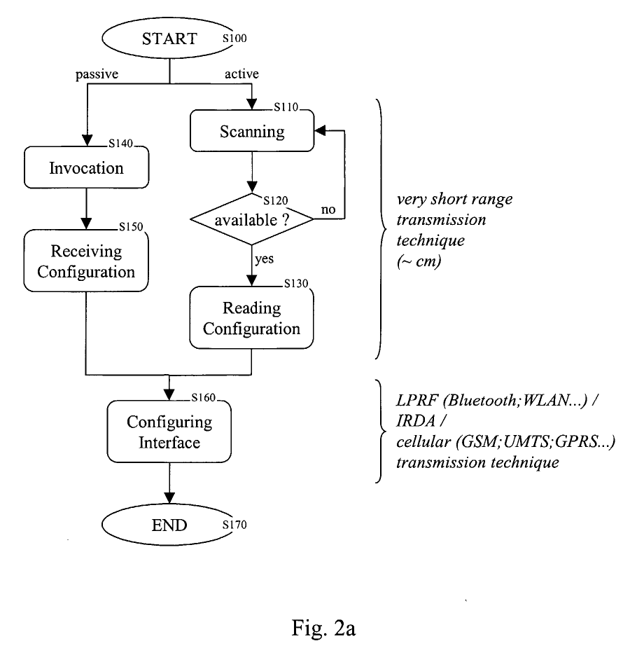

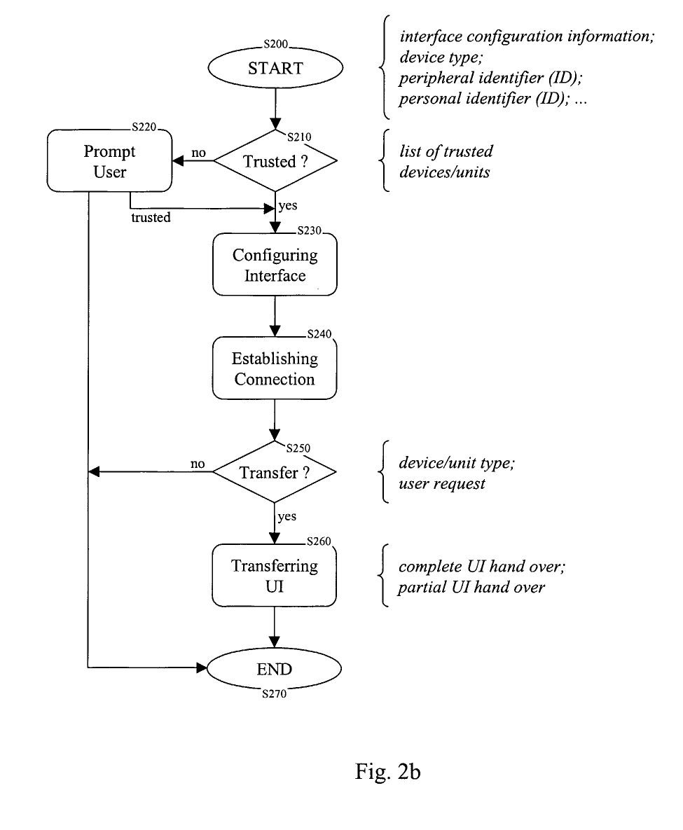

FIG. 2a illustrates schematically first operational sequence relating to the initiation procedure according to an embodiment of the present invention; and

FIG. 2b illustrates schematically second operational sequence relating to the initiation procedure according to an embodiment of the present invention.

Throughout the detailed description and the accompanying drawings same or similar units and devices will be referenced by same reference numerals for clarity purposes.

Technical embodiments of the inventive concept relate particularly to both a multipart radio terminal device arrangement and an arrangement of radio terminal devices. Specific embodiments thereof will be described in detail below.

With reference to FIG. 1, an example arrangement 10 is depicted which shall represent a multipart radio terminal device arrangement with several supplementary external equipment such as a core radio terminal device with wireless connected radio terminal peripheral devices.

In detail, the arrangement 10 comprises a core device 200 and two peripheral devices 100, 150 representing any arbitrary number of peripheral devices. For the way of illustration, a selection of functional units of the core device and the peripheral devices is also illustrated. The illustrated functional units relate to specific functional units being relevant in view of the present invention. For proper operation and functioning the core device and the peripheral devices comprise further functional units. Complete implementations of the core device and the peripheral devices are out of the scope of the present invention.

The core device 200 of the radio terminal device arrangement 10 provides a cellular interface 230 via which the core device 200 is capable to communicate over a radio communication connection 20 in a cellular network such a public land mobile network (PLMN), which is herein exemplary depicted in the form of a GSM (global system for mobile communications) and GPRS (general packet radio service) system.

The example GSM with GPRS shall represent a typical up-to-date cellular network supporting circuit-switched and packet-switched communication connections. A switching unit 330 comprising a mobile services switching center (MSC) and a serving GPRS support node (SGSN) enables the circuit-switched and packet-switched services in the cellular network, respectively. A gateway unit 340 comprising a gateway mobile service switching center (GSMC) and a gateway GPRS support node (GGSN) serves for the communications of the cellular network with external networks. In detail, the gateway mobile service switching center (GSMC) attends on circuit-switched communication to for instance a public land mobile network (PLMN) or a public switched telephone network (PSTN). The gateway GPRS support node (GGSN) is responsible for communications with external packet-switched networks such as a public land mobile network (PLMN) or the Internet.

Radio terminal devices communicate with the switching unit 330 and the gateway unit 340 via a radio access network (RAN) which is constituted by at least one base station controller (BSC) 320 managing at least one base station (BS) 310, which operates a radio interface to the radio terminal devices of the cellular network for radio communications therewith.

It shall be noted that the specific implementation of the cellular network is out of the scope of the present invention such that the present invention is not limited to any particular cellular network.

Referring back to the core device 200, functional units including a cellular interface 230, a wireless transceiver 220 and identification means 210 are implemented therein. In correspondence to the implementation of the core device 200, the peripheral devices 100 and 150 each comprise functional units including identification means 110 and a wireless interface 120.

The wireless interfaces 220 and 120 of the core device 200 and the peripheral devices 100 and 150 shall represent illustratively any wireless communications technology realizing communications therebetween. Low power radio frequency (RF) transceivers represent one typical class of wireless interfaces in the field of wireless communications applicable for data and voice signal communications. In particular, Bluetooth, wireless local area network (WLAN) and digital enhanced cordless telecommunication (DECT) can be classed as belonging to the field of low power radio frequency (RF) technology. But also infrared-based (IRDA: infrared data association) transceivers are applicable for wireless data and voice signal communications. As explained above, the inventive concept supports fast establishing of data communication connections via wireless communication interfaces in general such that the wireless interfaces 220 and 120 may also address cellular communication technology in the form of cellular interfaces. Corresponding embodiments will be described in FIG. 1e.

In the field of multipart radio terminal device arrangement, low power radio frequency (RF) technology is typically the wireless communication technology of choice, such that the wireless interfaces 220 and 120 may be implemented as low power radio frequency (RF) transceivers and more particularly as Bluetooth transceivers.

The identification means 210 and 110 relates also to a wireless exchange of information but with the difference that the identification means 210 and 110 shall be limited to a capability to exchange predefined information or a set of predefined information therebetween via information exchange paths 31 and 32, respectively. The designation information exchange shall further emphasis that in contrast to wireless communication technology as introduced above in conjunction with the wireless interfaces 220 and 120 the identification means 210 and 110 need principally not to be capable for bidirectional data communications which is known in combination with wireless communication technology allowing for constituting a wireless data communication network (such as cellular networks, Bluetooth, WLAN etc).

Moreover, the identification means 210 and 110 shall operate over very short spacious distances; i.e. over distances which are significantly shorter than the operation distances of wireless data communication technology, which may for instance vary from the order of meters (Bluetooth) to the order of hundreds for meters (WLAN) depending naturally on the employed technology and/or environmental effects. In particular, the identification means 210 and 110 may operate at a spacious distance in the order of centimeters.

The purpose of the implementation both the identification means 110 and 210 as well as the wireless interfaces 120 and 220 is to selectively limit the information exchange to devices being located in proximity whereas the communication connection constituted afterwards on the basis of information exchanged is operable within a spacious distance defined by the employed technology. This concept serves as a kind of authentication methodology when assuming that the required spacious approach can not take place accidentally, unnoticed and unintentionally. Conclusively, due to the fact that a constitution of a communication connection is operated by information exchange limited by spacious operation distance, a misuse by an unauthorized third party is prevented.

A suitable implementation of identification means 210 and 110 may be realized by employing radio frequency identification (RFID) technology comprising radio frequency identification (RFID) transponders and radio frequency identification (RFID) readers with information reading and/or writing capability. Depending on the design such radio frequency identification (RFID) transponders are applicable to provide information that is obtainable by a corresponding reader via a radio frequency (RF) connection.

In detail, radio frequency identification (RFID) transponders also referred to as radio frequency identification (RFID) tags are widely used for labeling objects, to establish person's identities and to recognize objects provided with radio frequency identification (RFID) transponders and attending obtainable information. Basically, radio frequency identification (RFID) transponders include an electronic circuit and a radio frequency (RF) interface coupled to an antenna contained in a small container. Passive radio frequency identification (RFID) transponders are activated by a radio frequency identification (RFID) reader which generates an interrogation signal, for example a radio frequency signal at a certain frequency. Active radio frequency identification (RFID) transponders comprise a power supply such as a battery for energizing the electronic components.

Passive inductive radio frequency identification (RFID) transponders are energized by passing through an energizing electromagnetic field, i.e. the interrogation signal. The radio frequency identification (RFID) transponders resonate at a frequency of the electromagnetic field that causes interference in the electromagnetic field that can be detected and evaluated by the radio frequency identification (RFID) reader. The amount of information that can be provided by passive inductive radio frequency identification (RFID) transponders and their transmission range is limited. Passive or active back scatter radio frequency identification (RFID) transponders reflect a small amount of the electromagnetic energy of an interrogation signal radiated by the radio frequency identification (RFID) reader. The reflected signal can be modulated or encoded in any way to embed information stored in the radio frequency identification (RFID) transponder to be transmitted to the radio frequency identification (RFID) reader. In detail, back scatter radio frequency identification (RFID) transponders receive the electromagnetic energy of the interrogation signal and convert a small amount of the electromagnetic energy for energizing the electronic components of the radio frequency identification (RFID) transponder. The radio frequency identification (RFID) transponder components can generate a data stream comprising a clock signal and stored radio frequency identification (RFID) transponder information to be modulated or encoded on the reflected signal.

Two-way active radio frequency identification (RFID) transponders include a miniaturized transceiver and are conventionally based on microprocessor technology. Two-way active radio frequency identification (RFID) transponders may be polled for data transmission or may transmit in a self-controlled way. The microprocessor technology allows performing software algorithms for parsing received (interrogation) radio frequency (RF) signals and for generating corresponding radio frequency (RF) response signals. Back scatter radio frequency identification (RFID) transponders and two-way radio frequency identification (RFID) transponders allow for provision of a larger amount of information and have a longer transmission range. Depending on the complexity of the radio frequency identification (RFID) transponders, the information stored non-volatile in the radio frequency identification (RFID) transponders may be read-only information or is modifiable (re-programmable) by the radio frequency identification (RFID) transponder reader.

Radio frequency identification (RFID) transponders are used in numerous application fields such as information storage devices allowing wireless read-out access. In detail application fields may comprise electronic article surveillance (EAS), storage administration systems, anti-theft systems, access controls, identification systems (persons, pets, wild life, children etc.), toll collection, traffic management systems, rail car identification, high value asset controls and the like. The fields of applications are not limited to the given enumeration. The operation frequency of radio frequency identification (RFID) transponders lies within a frequency range of several kilohertz up to several gigahertz.

Another suitable implementation of identification means 210 and 110 may be realized by optically detectable information-carrying signatures such as bar codes and similar codes and an optical signature reader such as a bar code reader. The optically detectable signature may be presented on a display and the optical signature reader may be realized by a digital camera taking the displayed signature for being analyzed to obtain the information carried by the signature. The presenting of the signature by a display enables to provide dynamically optically detectable signature carrying different information. Alternatively, permanently provided optically detectable signatures (for instance as adhesive labels) provide for static information carried thereby. Such an implementation fulfils also the requirement of information exchange restricted to proximity, i.e. a short operation distance.

A further suitable implementation of identification means 210 and 110 may be realized on the basis of magnetic information-carrying strips and magnetic strip readers.

With reference to FIG. 1b, a particular embodiment of the arrangement 10 of FIG. 1a may provide for radio frequency identification (RFID) transponders 111 as identification means 110 in each of the peripheral devices 100 and 150 (for simplification only peripheral device 100 is depicted in FIG. 1b) and a radio frequency identification (RFID) reader 211 as identification means 210 in the core device 200. That means that the radio frequency identification (RFID) reader 211 of the core device 200 is capable to scan the environment thereof for detecting a radio frequency identification (RFID) transponder. Once such a radio frequency identification (RFID) transponder is brought into an operation/detection distance of the radio frequency identification (RFID) reader 211, the radio frequency identification (RFID) reader 211 obtains via a radio frequency signals information stored and provided by the detected radio frequency identification (RFID) transponder such as radio frequency identification (RFID) transponder 111.

In detail, the radio frequency identification (RFID) reader 211 may generated repeatedly an interrogation signal 45 which serves in conjunction with passive radio frequency identification (RFID) transponder 111 as an energizing signal and causes the radio frequency identification (RFID) transponder 111 to re-transmit 46 information stored therein. In conjunction with an active radio frequency identification (RFID) transponder 111 the radio frequency identification (RFID) transponder 111 may be send into page scan mode by the interrogation signal 45 resulting in a speeding up of the re-transmission 46 of information stored therein.

With reference to FIG. 1c, an alternative particular embodiment of the arrangement 10 of FIG. 1a may provide for radio frequency identification (RFID) reader 112 as identification means 110 in each of the peripheral devices 100 and 150 (for simplification only peripheral device 100 is depicted in FIG. 1c) and a radio frequency identification (RFID) transponder/reader 212 as identification means 210 in the core device 200. That means that that the radio frequency identification (RFID) transponder/reader 212 of the core device 200 is supplied with information 47 by one of the peripheral devices 100 and 150, respectively, as the radio frequency identification (RFID) reader 112 of the one of the peripheral devices 100 and 150, respectively, is activated (by user interaction) for information exchange. The core device 200 as well as the one in question of the peripheral devices 100 and 150 have to be arranged within the operation distance.

Those skilled in the art will appreciate that the various types of active and passive radio frequency identification (RFID) transponders as well as radio frequency identification (RFID) readers capable to read from and/or write in information frequency identification (RFID) transponders allow for numerous implementation each allowing to exchange information in the aforementioned manner described in detail.

One aim of the information exchange between core device 200 and peripheral devices 100 or 150 is to allow constitution of wireless data communication connections 42 and/or 41 between core device 200 and peripheral device 100 and/or peripheral device 150. With reference to FIG. 1d, exemplary wireless data communication connection 42 and 41 operated by the wireless interface 220 of the core device 200 and the wireless interfaces 120 of the peripheral devices 100 and 150 are illustrated. With reference to a multipart radio terminal device arrangement it shall be noted that the constitution of the communication connection between core device 200 and one or more peripheral devices such as peripheral devices 100 and 150 does not only relate to the establishment of the communication connections such as those communication connections 42 and 41 established between core device 200 as well as peripheral devices 100 and 150. Rather, during the constitution of the communication connection between core device and one or more peripheral devices of a multipart radio terminal device arrangement precautions have to be taken in view of the user interface of the multipart radio terminal device arrangement realized on one or more peripheral devices thereof. As aforementioned the peripheral devices provide for physical and logical interfaces to the user for operating the multipart radio terminal device arrangement. That means that the operation of the core device is operable with the peripheral devices serving for the interfaces to the user and by the means of the peripheral devices the user of the multipart radio terminal device arrangement exercises control over the functionality of the multipart radio terminal device arrangement. That means further that each time a communication connection between core device and a peripheral device is established or disestablished the hand over of the control over the core device of the multipart radio terminal device arrangement by the peripheral devices may have to be taken into consideration to ensure proper function and usability of the multipart radio terminal device arrangement.

With reference to FIG. 1e, an example arrangement is depicted which shall represent an arrangement of radio terminal devices being wireless connected with each other. In detail, the arrangement of FIG. 1e comprises two radio terminal devices 400 and 500 each including for instance a cellular interface 230, a wireless interface 220 and identification means 210, to each of which the remarks given above apply.

For the way of illustration, a selection of functional units of the radio terminal devices 40 and 500 is illustrated in addition. The illustrated functional units relate to specific functional units being relevant in view of the present invention. For proper operation and functioning the radio terminal devices comprise further functional units. Complete implementations of the radio terminal devices are out of the scope of the present invention.

The radio terminal devices 400 and 500 of the arrangement provides a radio interface such as the illustrated cellular interface 230, by which the radio terminal devices 400 and 500 are capable to communicate over a radio communication connection 20 in a cellular network such as a public land mobile network (PLMN), which is herein exemplary depicted in the form of a GSM (global system for mobile communications) and GPRS (general packet radio service) system. The cellular network shall be indicated by the depicted base station (BS) 310 and base station controller (BSC) 320 representing a radio access network (RAN) of the cellular network. An example cellular network is described in detail above and remarks given thereto shall apply also in conjunction with the embodiment referred herein.

Another aim of the inventive concept is to allow wireless data communication between radio terminal device 400 and radio terminal device 500 via a wireless communication connection. Therefore, the information is exchanged via the identification means 210 of the radio terminal devices 400 and 500. On the basis of the exchanged information the communication between both the radio terminal device 400 and radio terminal device 500 is constituted. That means in a first sequence information is exchanged via the identification means 210. The implementation may be realized in correspondence with the embodiments described with reference to FIG. 1b and FIG. 1c, respectively, providing for radio frequency identification (RFID) transponders and radio frequency identification (RFID) readers as identification means.

Further, the wireless communication connection to be established and constituted is operated via a wireless interface such as the wireless interfaces 220 or the cellular interfaces 230 implemented in the radio terminal devices 400 and 500, respectively. When employing the cellular interfaces 230 for establishing the communication connection the wireless transceivers 220 depicted as units of the radio terminal devices 400 and 500 in FIG. 1e are obsolete.

In a second sequence the wireless communication connection is established between the radio terminal devices 400 and 500 via either the wireless interfaces 220 or the cellular interfaces 230. In final sequence the taking over of at least partly control by the connection initiating radio terminal device over the other radio terminal device is taken into consideration.

The detailed operations relating to the constitution of a communication connection in accordance with the present invention will be discussed in the description below referring to FIG. 2a and 2b. In order to cover both multipart radio arrangements such as described with reference to FIG. 1a and the arrangement of radio terminal devices such as described with reference to FIG. 1e the device/terminal device which initiates the communication connection via the wireless or cellular interface will be designated in the following as information-obtaining device. Accordingly, the counterpart device/terminal device participating in the communication connection will be designated in the following as information-providing device. In view of the multipart radio terminal device arrangement illustrated in FIG. 1a, the information-obtaining device corresponds to the core device 200, whereas the information-providing device corresponds to one of the peripheral devices 100 and 150. Further, in view of the arrangement of radio terminal device illustrated in FIG. 1e, the information-obtaining device corresponds to one of the radio terminal devices 400 and 500 and the information-providing device corresponds to the other one thereof.

FIG. 2a illustrates schematically an operational sequence relating to the initiation procedure according to an embodiment of the present invention.

In an operation S100, the sequence for fast constitution of a communication connection within a radio terminal device arrangement or an arrangement of radio terminal devices is initiated.

With reference to the embodiments described in detail with reference to FIG. 1a the information allowing to constitute a communication connection may be obtained by a scanning process or may be attended by a pushing process. The scanning process will be designated as active information retrieval whereas the pushing process will be designated as passive information retrieval. Accordingly, the operational sequence branches into two sets of operations each dedicated to the active and passive information retrieval, respectively.

Firstly, the active information retrieval shall be described with resect to operations S110 to S130. Secondly, the passive information retrieval shall be explained with reference to operations S140 and S150. Those skilled in the art will appreciate on the basis of the description below that in fact the specific information retrieval is only one aspect of the inventive concept such that either one or both processes may be applicable without being limited specifically thereto. In operation S110 and S120, the information-obtaining device scans within an operation distance defined by the specific technology used for the information exchange by an information-providing device from which information shall be obtained. The scanning operation may be performed automatically or may be initiated on a user interaction against the information-obtaining device. This active information retrieval process may be suitable for information retrieval in a radio terminal device arrangement or an arrangement of radio terminal devices, in which the information-obtaining device implements active identification means (such as a RFID reader 211) and the information-providing device implements passive identification means (such as an active/passive RFID transponder 111). This arrangement corresponds to one of the embodiments described with reference to FIG. 1b.

In an operation S120, during scanning operation there is repeatedly checked whether information can be obtained.

In an operation S130, the information-obtaining device has detected that information can be obtained from an information-providing device and obtains the provided information therefrom via the identification means implemented in the information-obtaining device as well as in the information-providing device. The information is now available for being processed by the information-obtaining device.

In an operation S140, the information-obtaining device receives an invocation to receive information. The invocation is supplied by the information-providing device to the information-obtaining device via the identification means implemented in the information-obtaining device as well as in the information-providing device. This passive information retrieval process may be suitable for information retrieval in a radio terminal device arrangement or an arrangement of radio terminal devices, in which the information-obtaining device implements passive identification means (such as a RFID transponder or reader 212) and the information-providing device implements active identification means (such as a RFID reader 112). This arrangement corresponds to one of the embodiments described with reference to FIG. 1c.

In an operation S 150, the information-obtaining device receives the information from the information-providing device such that the information is now available for being processed by the information-obtaining device.

The information in question relates in particular to configuration information, which allows to constitute a communication connection between the information-obtaining device and the information-providing device via wireless communication interfaces (such as wireless interfaces 200 and cellular interfaces 230) adapted for wireless data communication therebetween. Accordingly, the information in question comprises in detail a set of configuration information, which allows for fast constitution according to the inventive concept. The information may include one or more of the following configuration information, comprising:
configuration information relating to communication interface specific configuration information necessary to establish a wireless communication connection therewith;
type information about a type of the device providing the information;
device identifier (ID) relating to a device providing the information such as a device identifier identifying a peripheral device; and
personal identifier (ID) for filtering and/or authentication purposes.

In an operation S160, the information is processed to configure the wireless communication interfaces, wherein the configuration comprises an establishing of a communication connection and a configuration of the operation of the information-obtaining and information-providing devices connected over the communication connection. In particular, the configured communication interface in question may correspond to the wireless interfaces 120 and 220 or to the cellular interfaces 230 of the information-obtaining and information-providing devices, respectively. A more detailed description of the configuration operation of the communication interfaces will be given with reference to FIG. 2b referred to below.

As aforementioned the communication connection between mobile radio terminal devices within an arrangement thereof or devices of a multipart mobile radio terminal device arrangement is established by wireless communication interfaces such as the cellular interfaces 230 and the wireless interfaces 220 that may be implemented as low power radio frequency transceivers such as Bluetooth transceivers and WLAN transceivers; IRDA (infrared data association) transceivers; and the like.

In an operation S170, the sequence for fast constitution of a communication connection within a radio terminal device arrangement or an arrangement of radio terminal devices is completed.

FIG. 2b illustrates schematically second operational sequence relating to the initiation procedure according to an embodiment of the present invention.

In an operation S200, the sequence for fast constitution of a communication connection within a radio terminal device arrangement or an arrangement of radio terminal devices on the basis of obtained configuration information is initiated. With reference to FIG. 2a a sequence relating to the obtaining of such configuration information has been described such that FIG. 2b will refer to the subsequent operations relating to the processing of the configuration information.

In an operation S210, the information-obtaining device checks on the basis of a list of trusted devices and units, respectively, whether the information-providing device is a trusted device and unit, respectively. The checking is based on the information obtained from the information-providing device, and especially the checking is operated in accordance with the unit identifier and/or personal identifier comprised therein.

Such checking shall ensure that only devices and units are allowed to participate in the fast constitution of a communication connection, which are trustworthy; the state of the art manual acknowledgement of communication connection establishment by user interaction is substituted with an automatic checking against a list of trusted devices and units, respectively. The list of devices/units is under control of a user who is enabled to add and/or remove entries thereof to guarantee user-individual control. Effectively, misuse by unauthorized third parties is prevented.

In case the checking results in an acknowledgement that the information-providing device is trustworthy, the operational sequence constitutes with operation S230. Otherwise the operational sequence may end or the operational sequence may branch to an operation S220, in which the user may be prompted to accept or reject the information-providing device as trusted unit/device. Correspondingly, the operational sequence may continue thereafter with operation S230 (information-providing device trusted) or may end.

In an operation S230, the communication interface such the wireless interface 220 of the information-obtaining device such as the core device 200 is configured on the basis of the obtained information to establish a communication connection to the information-providing device such as peripheral devices 100 and 150, respectively. And on the basis of the configured communication interface the communication connection is subsequently established in an operation S240. The obtained information comprises the required information allowing for configuring the communication interface and for establishing the communication interface, namely, configuration information relating to requirements required to establish a wireless communication connection and personal identifier (ID) for filtering and/or authentication purposes.

In an operation S250, it is further checked whether control over the operation of the information-obtaining device is to be handed over to the new wirelessly connected device corresponding to the information-providing device.

With reference to a multipart radio terminal device arrangement those skilled in the art will appreciate that the handing over of control over the core device to one or more peripheral devices is required since the peripheral devices implement the interfaces to the user of such a multipart radio terminal device arrangement. Correspondingly, in case a new peripheral device is connected to the core device of the multipart radio terminal device arrangement, the control over the core device may have to be at least partially transferred to the new peripheral device in accordance with the functionality provided thereby.

In order to enlighten more detailed the transfer of control to peripheral devices of a multipart radio terminal device arrangement an example procedure shall be outlined. Assuming that a multipart radio terminal device arrangement is constituted by a core device connected wireless to a communicator or PDA-styled (personal digital assistant) peripheral device for performing communications with the cellular network to which the core device is subscribed. At first the control over the core device is carried out by interacting of the user with the PDA-styled peripheral device offering interfaces to the user therefor. Further it shall be assumed that the user of the multipart radio terminal device arrangement whishes to substitute the PDA-styled peripheral device with a classical phone-styled peripheral device to be connected wireless to the core device. As described above with reference to the operational sequences of FIG. 2a and FIG. 2b, respectively, the phone-styled peripheral device is brought into proximity of the core device allowing of exchanging configuration information via the identification means such that the core device is capable to obtain the configuration information provided by the phone-styled peripheral device. On the basis of the obtained configuration information the core device is able to establish a wireless communication connection to the phone-styled peripheral device provided that the phone-styled peripheral device has been identified as a trusted device.

After establishment of the wireless communication connection the control over the core device has to be transferred to the newly connected phone-styled peripheral device which requires a hand over of the control from the previously active PDA-styled peripheral device to the phone-styled peripheral device offering also interfaces to the user for interaction with the multipart radio terminal device arrangement. Next to a successful transfer of the control to the PDA-styled peripheral device the connection of the PDA-styled peripheral device with the core device can be disestablished.

Alternatively, the connection of the PDA-styled peripheral device with the core device may be maintained and the control over the core device is partially handed over from the PDA-styled peripheral device to the newly connected phone-styled peripheral device. For instance the PDA-styled peripheral device may be operable with e-mail and SMS (short message service) communications whereas the phone-styled peripheral device may be operable with phone calls.

Further alternatively, it may be necessary that the communication connection to the PDA-styled peripheral device be maintained due to an application running thereon requiring the communication connection. For instance, the application may be a browser application.

With reference to an arrangement of radio terminal device the transfer of control over one of the radio terminal devices via the other one is applicable and advantageous in conjunction with for example server-client applications or multi-user applications. In such an environment relating to interoperation of radio terminal devices at least partially and selective control over either one of the radio terminal devices by the other one is applicable for gaining either partially or totally control over the operation, the interfaces to the user and applications of the controlled radio terminal device. For instance when referring to maintenance, the control over functionality of the controlled radio terminal device is advantageous for the person performing maintenance procedures and allows speeding up maintenance carried out by a specific terminal device arranged for maintenance procedures. For instance when referring to multi-user application environments such as multi-user game application environments, the transfer of control over a specific application allows for remote control thereof for instance relating to a configuring of the application or a managing of the operational sequence of the application.

In an operation S260, the control over the information-providing device is selectively and at least partially transferred to the information-obtaining device. Selectively means that the control is transferred in accordance with the functionality and operability of the information-obtaining device, which determines the extent of control capable to be exercised by the information-providing device over the information-obtaining device. Partially, means that the control is restricted to specific limits defined by the information-obtaining device and/or the information-providing device, which is comparable with the selective transfer of the control. Moreover, the specific limits defined by the user or may be defined by applications currently performed on either one of the devices.

Additionally, the control can be handed over in opposite direction; i.e. the control over the information-obtaining device is selectively and at least partially transferred to the information-providing device. The explanation given above applies likewise hereto in a vice versa manner.

In an operation S270, the sequence for fast constitution of a communication connection within a radio terminal device arrangement or an arrangement of radio terminal devices on the basis of obtained configuration information is completed.

Even though the invention is described above with reference to embodiments according to the accompanying drawings, it is clear that the invention is not restricted thereto but it can be modified in several ways within the scope of the appended claims.

1. Mobile device allowing a fast constitution of a communication connection providing for device interoperability, comprising at least one wireless communication interface and identification means, wherein said wireless communication interface is adapted to provide a wireless communication with another mobile device, wherein said identification means is adapted to obtain configuration information from said other mobile device being arranged to provide said configuration information;
wherein said configuration information is adapted to provide a communication connection with said other mobile device via said wireless communication interface and a hand over of at least partial control over said mobile device to said other mobile device or vice versa.

2. Mobile device according to claim 1, wherein said at least partial control corresponds to a selective control corresponding to functionality of at least one of said mobile device and said other mobile device.

3. Mobile device according to claim 1, wherein said control relates to at least one of a group of controls comprising control over operations of said devices, control over one or more interfaces of said devices comprising user interfaces and control over one or more applications of said devices.

4. Mobile device according to claim 1, wherein said identification means comprise radio frequency identification (RFID) means, preferably one out of a group including a radio frequency identification reader and a radio frequency identification transponder.

5. Mobile device according to claim 1, wherein said other mobile device implements an identification means operable with said identification means of said mobile device, wherein said identification means comprise preferably radio frequency identification (RFID) means, more preferably one out of said group including a radio frequency identification transponder, a radio frequency identification transponder reader and a radio frequency identification transponder reader capable for writing.

6. Mobile device according to claim 1, wherein said configuration information comprises at least one out of a group of configuration information including:
communication interface configuration information;
device type;
device identifier; and
personal identifier.

7. Mobile device according to claim 1, wherein said wireless communication interface is one out of a group of interfaces including a low power radio frequency interface, an infrared-based communication interface and a cellular interface.

8. Mobile device according to claim 7, wherein said low power radio frequency interface is one out of a group of interfaces including a Bluetooth interface and a wireless local area network interface.

9. Mobile device according to claim 1, wherein at least one of said mobile device and said other mobile device is another radio terminal device.

10. Mobile device according to claim 1, wherein at least one of said mobile device and said other mobile device is a core device of a multipart radio terminal device arrangement and said other one is a peripheral device of said multipart radio terminal device arrangement.

11. System allowing fast constitution of a communication connection providing for device interoperability, comprising a mobile device and at least another mobile device; wherein said mobile device and said at least other mobile device each comprise at least one wireless communication interface and identification means, wherein said wireless communication interfaces allows for wireless communication between said mobile device and said another mobile device, wherein said identification means allows to obtain configuration information by said mobile device from said other mobile device;
wherein said configuration information is adapted to provide a communication connection with said other mobile device via said wireless communication interfaces and a hand over of at least partial control over said mobile device to said other mobile device or vice versa.

12. Method for fast constitution of a communication connection providing for interoperability of a mobile device with another mobile device, comprising
obtaining configuration information from said other mobile device by identification means comprised by said mobile device;
processing said configuration information by said mobile device to constitute communications with said other mobile device by
establishing a communication connection with said other mobile device via a wireless communication interface comprised by said mobile device; and
handing over at least partially control over said mobile device to said other mobile device, or vice versa.

13. Method according to claim 12, wherein said handing over said at least partial control corresponds to a handing over of selective control, wherein said selectivity depends on functionality of at least one of said mobile device and said other mobile device.

14. Method according to claim 12, further comprising:
checking on the basis of said configuration information whether said other mobile device is trustworthy.

15. Method according to claim 12, further comprising:
transferring said control in accordance with said configuration information.

16. Method according to claim 12, comprising:
disestablishing a previously constituted communication connection to a third mobile device; and
transferring control previously exercised by said third mobile device over said mobile device to said other mobile device.

17. Method according to claim 12, wherein said mobile device comprises at least one wireless communication interface and identification means, wherein said wireless communication interface is adapted to provide a wireless communication with said other mobile device wherein said identification means is adapted to obtain said configuration information from said other mobile device and wherein said configuration information is adapted to provide a communication connection with said other mobile device via said wireless communication interface and a hand over of at least partial control over said mobile device to said other mobile device or vice versa.

18. Computer program product for executing a method allowing of fast constitution of a communication connection providing for device interoperability, comprising program code sections for carrying out the steps of claim 12, when said program is run on a computer, a terminal, a network device, a mobile terminal or a mobile communication enabled terminal.

19. Computer program product for executing a method allowing of fast constitution of a communication connection providing for device interoperability, comprising program code sections stored on a machine-readable medium for carrying out the steps of claim 12, when said program product is run on a computer, a terminal, a network device, a mobile terminal, or a mobile communication enabled terminal.
